(19) United States
(12) Patent Application Publication
(10) Pub. No.: US 2019/0303099 A1
(43) Pub. Date: Oct. 3, 2019

(54) SOUND COLLECTION APPARATUS AND SOUND COLLECTION METHOD

(71) Applicant: Panasonic Intellectual Property Management Co., Ltd., Osaka (JP)

(72) Inventors: Takao ADACHI, Hyogo (JP); Yoshifumi HIROSE, Kyoto (JP); Yusuke ADACHI, Osaka (JP); Masahiro NAKANISHI, Kyoto (JP)

(21) Appl. No.: 16/361,615

(22) Filed: Mar. 22, 2019

(30) Foreign Application Priority Data
Mar. 28, 2018 (JP) 2018-062922

(51) Int. Cl. G06F 3/16

(52) U.S. Cl. CPC G06F 3/167

(57) ABSTRACT

A sound collection apparatus and a sound collection method for accurately collecting a target sound are provided. A sound collection apparatus (1) collects an acoustic signal, and comprises: a first sensor (240) detecting a distance from the sound collection apparatus to an object around the sound collection apparatus to generate distant information indicative of the distance; a second sensor (230) detecting a motion of the sound collection apparatus to generate motion information indicative of the motion; a sound acquisition part (250) receiving a sound around the sound collection apparatus to generate an acoustic signal; and a controller (110) controlling collection of the acoustic signal; wherein the controller validates or invalidates the distance information based on the motion information and determines whether to collect the acoustic signal based on the distance information when the distance information is validated.

### TECHNICAL FIELD OF THE INVENTION

The present disclosure relates to a sound collection apparatus and a sound collection method for collecting an acoustic signal.

### BACKGROUND OF THE INVENTION

Patent Document 1 discloses a speech recognition apparatus recognizing an input speech from a microphone. The speech recognition apparatus includes a distance measuring sensor and adjusts a gain of the microphone depending on a distance between the microphone and a user measured by the distance measuring sensor. This speech recognition apparatus temporarily stops the operation of the distance measuring sensor in a speech section from the start of speech to the end of speech detected based on a speech power of the input speech. This suppresses noise generation by the distance measuring sensor to improve accuracy of voice identification.

Patent Document 2 discloses a speech recognition apparatus including an angle sensor. This speech recognition apparatus starts a speech recognition operation when an angle of the speech recognition apparatus detected by the angle sensor falls within a predetermined angular range. Therefore, the speech recognition operation can be started without a key operation performed by a user to start speech recognition.

Patent Document 1: Japanese Laid-Open Patent Publication No. 2009-229899

Patent Document 2: Japanese Laid-Open Patent Publication No. 2004-294945

### SUMMARY OF THE INVENTION

The present disclosure provides a sound collection apparatus and a sound collection method for accurately collecting a target sound.

A sound collection apparatus of the present disclosure is an apparatus collecting an acoustic signal. The sound collection apparatus comprises a first sensor detecting a distance from the sound collection apparatus to an object around the sound collection apparatus to generate distant information indicative of the distance, a second sensor detecting a motion of the sound collection apparatus to generate motion information indicative of the motion, a sound acquisition part receiving a sound around the sound collection apparatus to generate an acoustic signal, and a controller controlling collection of the acoustic signal. The controller validates or invalidates the distance information based on the motion information and determines whether to collect the acoustic signal based on the distance information when the distance information is validated.

These general and specific aspects may be implemented by a system, a method, and a computer program, as well as a combination thereof.

According to the sound collection apparatus and the sound collection method of the present disclosure, a target sound can accurately be collected.

### BRIEF DESCRIPTION OF DRAWINGS

FIG. 1 is a view showing an example of an appearance of a sound collection apparatus.

FIG. 2 is a view showing an example of mounting an electronic device on a measuring device to constitute the sound collection apparatus.

FIG. 3 is a diagram showing an example of an application example of the sound collection apparatus.

FIG. 4 is a block diagram showing an example of an electrical configuration of the sound collection apparatus.

FIG. 5 is a diagram showing an example of use of the sound collection apparatus.

FIG. 6 is a transition diagram of an operation mode.

FIG. 7 is a diagram showing validated/invalidated states of various pieces of information and a sound collection state corresponding to the operation mode.

FIG. 8 is a flowchart showing an example of the operation of the sound collection apparatus.

FIG. 9 is a block diagram showing an example of an internal configuration of an electronic device according to another embodiment.

### DETAILED DESCRIPTION OF THE INVENTION

### Knowledge Underlying the Present Disclosure

The speech recognition apparatus of Patent Document 1 detects a speech section from the start of speech to the end of speech based on a speech power of a quantized speech waveform. The speech recognition apparatus stops the operation of the distance measuring sensor during the speech section. Therefore, for example, if a large environmental noise is input to the microphone during a speech section, the speech section may continuously be recognized even though the user has moved away from the microphone, so that the end of speech cannot accurately be identified. The speech recognition apparatus of Patent Document 2 starts an operation when the angle of the speech recognition apparatus falls within a predetermined angular range. However, the angle during use differs depending on the height of a person using the speech recognition apparatus, so that the predetermined angular range cannot be determined. Therefore, it is difficult to accurately identify the start of speech. As described above, with the conventional techniques such as Patent Documents 1 and 2, the start of speech or the end of speech cannot accurately be identified, and a target sound cannot accurately be collected.

An object of a sound collection apparatus of the present disclosure is to accurately collect a target sound. Specifically, the sound collection apparatus of the present disclosure determines whether to validate or invalidate distance information generated by a distance sensor based on motion (specifically, acceleration) of the sound collection apparatus. When the distance information is validated, the sound collection apparatus of the present disclosure determines whether to collect sound based on the distance information. A valid period of the distance information is limited so as to prevent collection of an acoustic signal other than that of the target sound. As a result, the target sound is accurately collected.

### Embodiment

An embodiment will now be described with reference to the drawings. In an example described in this embodiment, a human voice is collected as a target sound.

### 1. Configuration of Sound Collection Apparatus

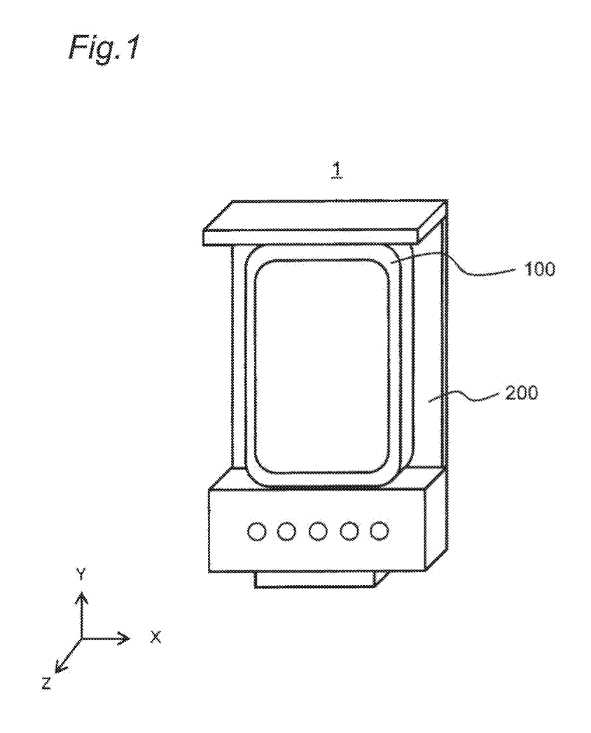

A configuration of the sound collection apparatus will be described with reference to FIGS. 1 to 4.

### 1.1 Overall Structure

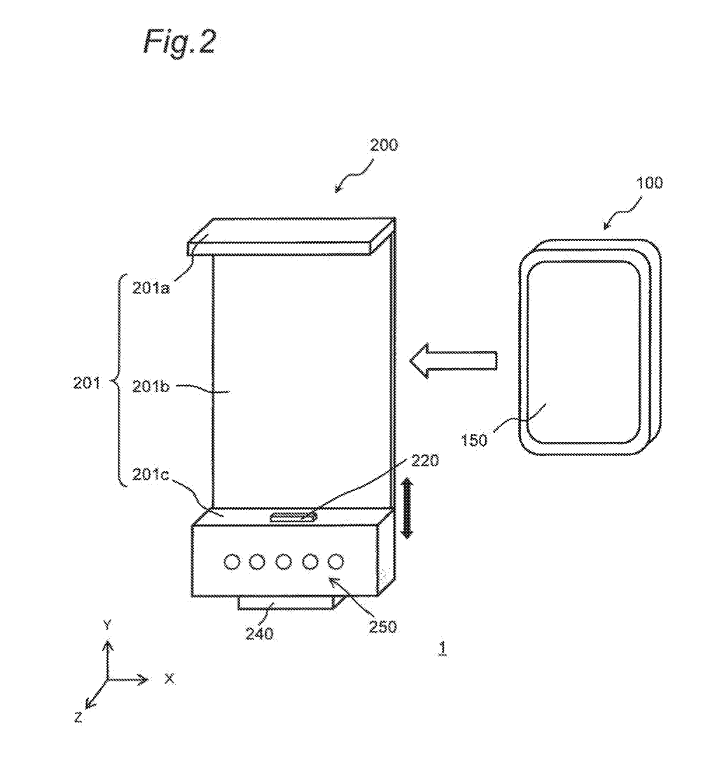

FIG. 1 shows an example of an appearance of the sound collection apparatus. FIG. 2 shows an example of mounting an electronic device on a measuring device to constitute the sound collection apparatus. A sound collection apparatus 1 of this embodiment is used for collecting a human voice during conversation, for example. Sound collection in this embodiment includes recording a sound that is a target sound.

As shown in FIGS. 1 and 2, the sound collection apparatus 1 includes an electronic device 100 and a measuring device 200 on which the electronic device 100 can be mounted. The electronic device 100 is a mobile terminal such as a smartphone or a tablet terminal, for example. The measuring device 200 is a peripheral device to which the electronic device 100 is connected and that communicates with the electronic device 100. The measuring device 200 includes a mounting part 201 that is a member mounting and fixing the electronic device 100. In an example, the mounting part 201 includes an upper plate 201a, a back plate 201b, and a lower block 201c to fix the electronic device 100 by sandwiching both ends thereof in a longitudinal direction (a Y-axis direction of FIGS. 1 and 2).

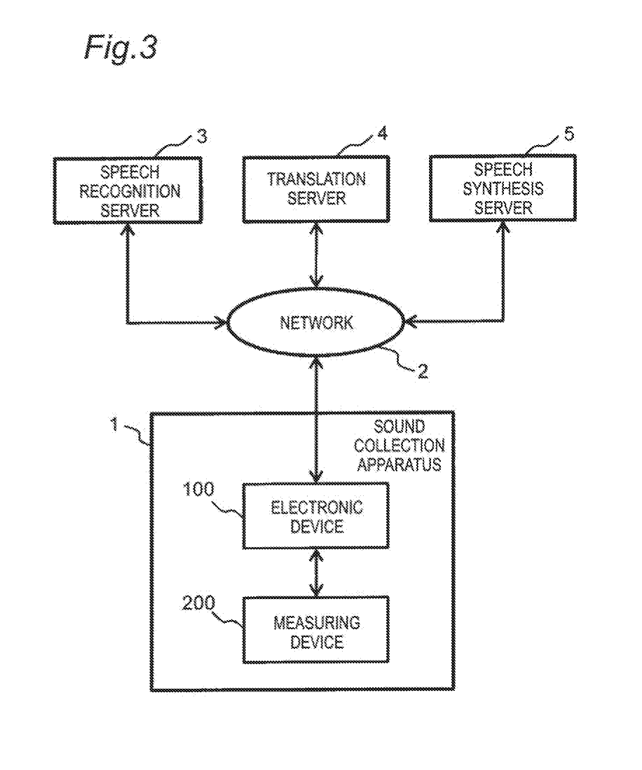

FIG. 3 shows an application example of the sound collection apparatus 1. The sound collection apparatus 1 of this embodiment can be used as, for example, a translation apparatus inputting a speech in a first language and outputting a result of translation of the input speech into a second language. As shown in FIG. 3, the sound collection apparatus 1 as described above performs data communication with each of a speech recognition server 3, a translation server 4, and a speech synthesis server 5 through a network 2 such as the Internet.

The speech recognition server 3 performs speech recognition of an acoustic signal corresponding to a speech of a speaker acquired from the sound collection apparatus 1 and generates speech recognition data (text data of a spoken sentence).

The translation server 4 performs translation from the first language to the second language and reverse translation from the second language to the first language. The translation server 4 generates translation data (text data of a translated sentence) from the speech recognition data acquired from the sound collection apparatus 1. The translation server 4 also generates reverse translation data (text data of a reverse-translated sentence) from the translation data.

The speech synthesis server 5 performs speech synthesis from the translation data acquired from the sound collection apparatus 1 to generate a speech signal.

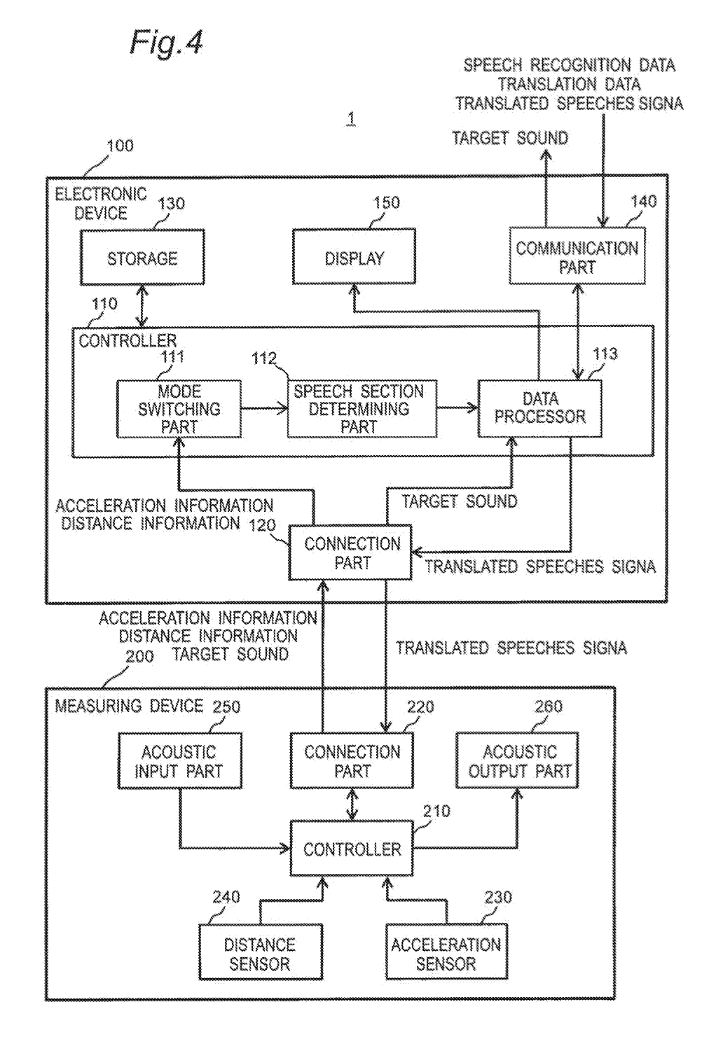

FIG. 4 exemplarily shows an electrical configuration of the sound collection apparatus 1. The sound collection apparatus 1 is made up of the electronic device 100 and the measuring device 200 communicating bidirectionally.

### 1.2 Configuration of Electronic Device

The electronic device 100 includes a controller 110, a connection part 120, a storage part 130, a communication part 140, and a display 150.

The controller 110 controls the entire electronic device 100. The controller 110 can be implemented by a semiconductor element etc. The controller 110 can be made up of a microcomputer, a CPU, an MPU, a DSP, an FPGA, or an ASIC, for example. The function of the controller 110 may be constituted only by hardware or may be implemented by combining hardware and software.

The controller 110 includes a mode switching part 111, a speech section determining part 112, and a data processor 113 as functional constituent elements.

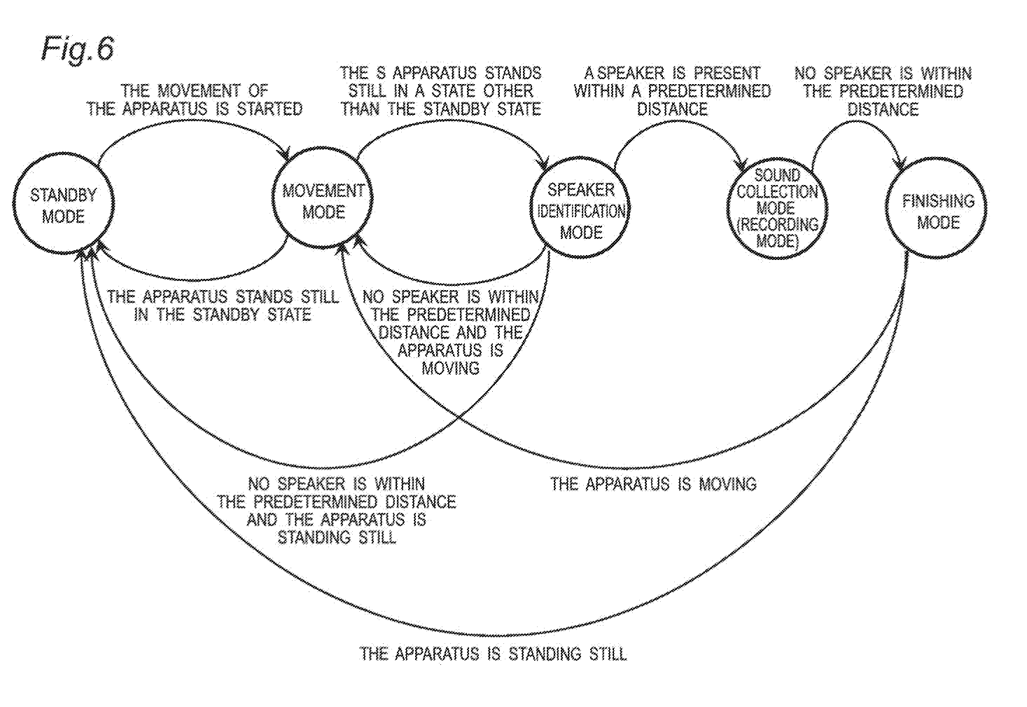

The mode switching part 111 switches an operation mode based on acceleration information output from an acceleration sensor 230 and distance information output from a distance sensor 240 (see FIG. 6). For example, at the timing of switching of the operation mode, the mode switching part 111 notifies the speech section determining part 112 of the current operation mode.

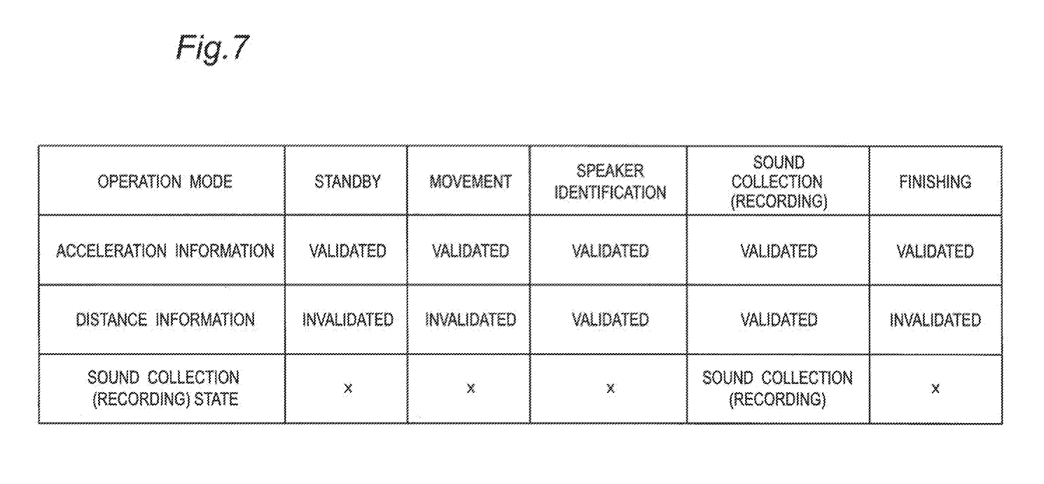

The speech section determining part 112 determines a sound collection section depending on the operation mode. For example, when receiving a notification of the current operation mode from the mode switching part 111, the speech section determining part 112 determines whether the current operation mode is a sound collection mode (see FIG. 7). The speech section determining part 112 determines a period from the start to the end of the sound collection mode as the sound collection section. The sound collection section corresponds to a section including a target sound out of acoustic signals acquired from the measuring device 200. In this embodiment, since a human voice is collected as a target sound, the sound collection section corresponds to a speech section from the start of speech to the end of speech. The speech section determining part 112 determines the period from the start to the end of the sound collection mode as the speech section and notifies the data processor 113 of the start and end of the speech section.

The data processor 113 processes (collects) acoustic signals in the speech section. For example, when receiving the notification of the start of the speech section, the data processor 113 starts storing the acoustic signals in the storage part 130. For example, when receiving the notification of the end of the speech section, the data processor 113 stops storing the acoustic signals in the storage part 130. For example, when the data processor 113 stops storing the acoustic signals, the data processor 113 outputs the acoustic signals corresponding to the speech section to the speech recognition server 3 via the communication part 190. The data processor 113 may start outputting the acoustic signals to the speech recognition server 3 when receiving the notification of the start of the speech section.

The connection part 120 includes a circuit communicating with an external device in conformity with a predetermined communication standard (e.g., LAN, Wi-Fi (registered trademark), Bluetooth (registered trademark), USB, HDMI (registered trademark)). In this embodiment, the connection part 120 is a USB terminal (female terminal). The electronic device 100 is electrically connected via the connection part 120 to the measuring device 200.

The storage part 130 can be implemented by, for example, a hard disk (HDD), an SSD, a RAM, a DRAM, a ferroelectric memory, a flash memory, a magnetic disk, or a combination thereof. The storage part 130 stores the acoustic signals of the target sound.

The communication part 140 performs data communication with the speech recognition server 3, the translation server 4, and the speech synthesis server 5 via the network 2 shown in FIG. 3. The communication part 140 includes a circuit communicating with an external device in conformity with a predetermined communication standard (e.g., LAN, Wi-Fi (registered trademark), Bluetooth (registered trademark), USB, HDMI (registered trademark)).

The display 150 is made up of a liquid crystal display device or an organic EL display device. The display 150 displays, for example, a translated sentence that is a translation result of a speech.

### 1.3 Structure of Measuring Device

The measuring device 200 includes a controller 210, a connection part 220, an acceleration sensor 230, a distance sensor 240, an acoustic input part (sound acquisition part) 250, and an acoustic output part 260.

The controller 210 controls the entire measuring device 200. The controller 210 transmits an acoustic signal via the connection part 220 to the electronic device 100. The controller 210 can be implemented by a semiconductor element etc. The controller 210 can be made up of a microcomputer, a CPU, an MPU, a DSP, an FPGA, and an ASIC, for example. The functions of the controller 210 may be constituted only by hardware or may be implemented by combining hardware and software.

The connection part 220 includes a circuit communicating with an external device in conformity with a predetermined communication standard (e.g., LAN, Wi-Fi (registered trademark), Bluetooth (registered trademark), USB, HDMI (registered trademark)). In this embodiment, the connection part 220 is a USB terminal (male terminal) and is connected to the USB terminal (female terminal) of the electronic device 100. The measuring device 200 is electrically connected via the connection part 220 to the electronic device 100.

The acceleration sensor 230 detects an acceleration of the sound collection apparatus 1 and generates acceleration information indicative of the acceleration. The acceleration information is an example of motion information indicative of motion such as moving and standing-still of the sound collection apparatus 1.

The distance sensor 240 detects a distance from the distance sensor 240 to an object located therearound and outputs distance information indicative of the distance. The distance sensor 240 is an infrared sensor, for example. The distance sensor 240 is attached to, for example, a lower surface in the Y-axis direction of the lower block 201c shown in FIG. 2.

The acoustic input part 250 receives an surrounding sound and generates an acoustic signal corresponding to the received sound. The acoustic input part 250 includes, for example, a microphone array, multiple amplifiers, and multiple A/D converters. The microphone array receives an surrounding sound (sound waves) with multiple microphones, converts the received sound into an electric signal, and outputs an analog sound signal. The amplifiers amplify respective analog acoustic signals output from the microphones. The A/D converters convert the acoustic signals output from the amplifiers from analog to digital. In this embodiment, the acoustic input part 250 is disposed in the lower block 201c shown in FIG. 2.

The acoustic output part 260 outputs an acoustic signal of voice etc. For example, the acoustic output part 260 outputs a speech signal corresponding to a translation result of a speech. The acoustic output part 260 includes a D/A converter, an amplifier, and a speaker, for example. The D/A converter converts the acoustic signal received from the controller 210 from digital to analog. The amplifier amplifies the analog acoustic signal. The speaker outputs the amplified analog acoustic signal.

### 2. Operation of Sound Collection Apparatus

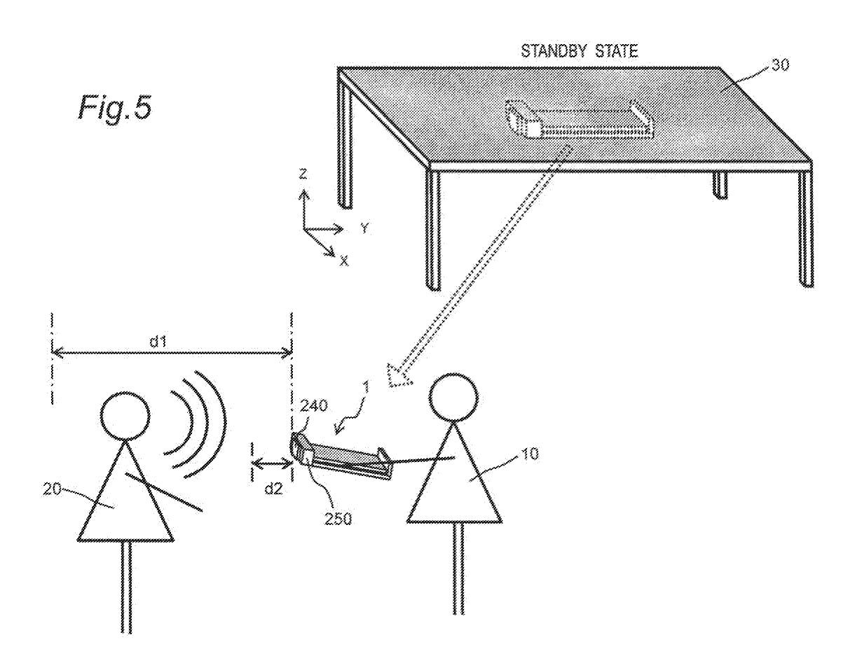

An operation of the sound collection apparatus 1 will be described with reference to FIGS. 5 to 8.

FIG. 5 shows an example of use of the sound collection apparatus 1. The sound collection apparatus 1 of this embodiment is a portable terminal. For example, at the time of use, a host 10 holds and uses the sound collection apparatus 1 in the hand with the distance sensor 240 and the acoustic input part 250 directed toward a speaker (a guest 20 or the host 10). For example, when the host 10 and the guest 20 talk face-to-face with each other, the host 10 alternately changes the direction of the sound collection apparatus 1 (the side disposed with the distance sensor 240 and the sound input section 250) to the host 10 side or the guest 20 side each time the speaker changes. Alternatively, when the guest 20 or the host 10 continuously speaks, the sound collection apparatus 1 is brought closer, and when the speaker has finished speaking, the sound collection apparatus 1 is moved away.

FIG. 6 shows a transition diagram of the operation mode. The operation mode of the sound collection apparatus 1 includes a standby mode, a movement mode, a speaker identification mode, a sound collection (recording) mode, and a finishing mode.

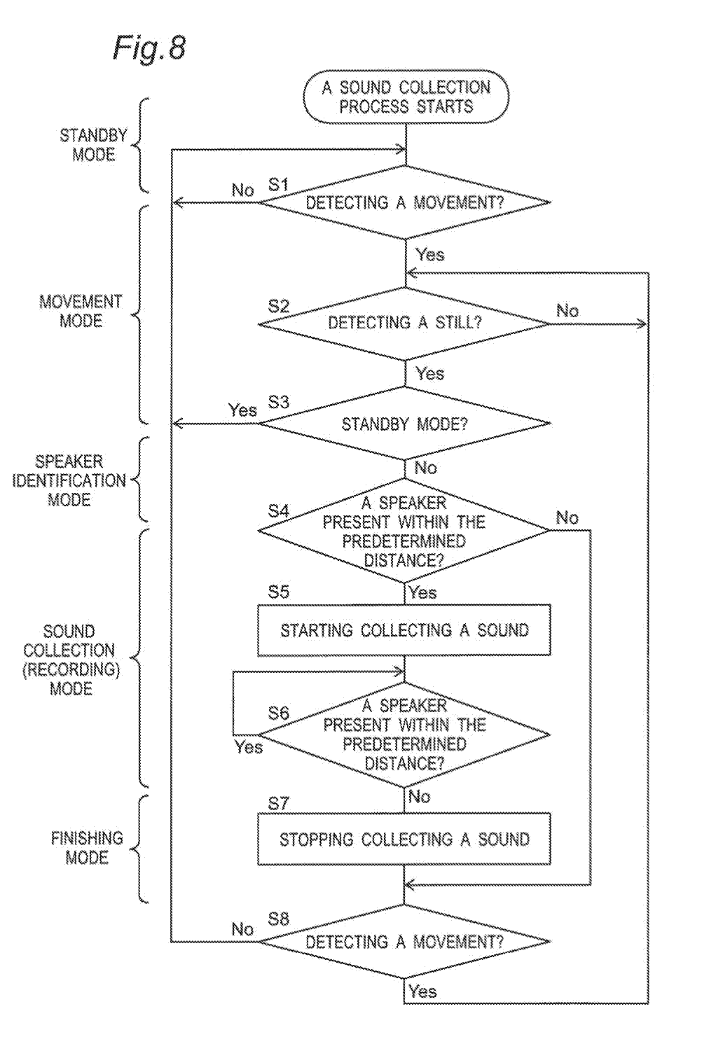

The standby mode is a mode initially set at the start of operation of a sound collection process shown in FIG. 8 (e.g., when the sound collection apparatus 1 is powered on). The standby mode is a state in which the sound collection apparatus 1 is standing still. For example, the standby mode is a state of flat placement such as when the sound collection apparatus 1 is placed on a table 30 as shown in FIG. 5. In this embodiment, the posture or position of the sound collection apparatus 1 at the start of operation is referred to as a standby state. The flat placement is placement in which a principal surface of the sound collection apparatus 1 is substantially flush with a horizontal plane (XY plane). The standby state is not limited to the flat placement and may be a posture in which a predetermined angle is formed relative to the horizontal plane. When the movement of the sound collection apparatus 1 is started, the operation mode shifts to the movement mode.

The movement mode is a mode set when the sound collection apparatus 1 is moving. In the movement mode, when the sound collection apparatus 1 stands still in the standby state, the operation mode returns to the standby mode, and when the sound collection apparatus 1 stands still in a state other than the standby state, the operation mode shifts to the speaker identification mode.

The speaker identification mode is a mode of detecting a speaker based on the distance information. In the speaker identification mode, if a speaker is present within a predetermined distance d1 from the distance sensor 240, the operation mode shifts to the sound collection mode. When no speaker is within the predetermined distance d1 from the distance sensor 240, the mode returns to the movement mode or the standby mode depending on the motion of the sound collection apparatus 1.

The sound collection mode is a mode of processing an acoustic signal generated by the acoustic input part 250. In this embodiment, the acoustic signal is stored in the storage part 130. Therefore, the sound collection mode is a mode of recording. In the sound collection mode, when the speaker is no longer present within the predetermined distance d1 from the distance sensor 240, the operation mode shifts to the finishing mode.

The finishing mode is a mode of determining whether the sound collection apparatus 1 is moving or standing still after completion of recording. The operation mode shifts to the standby mode or the movement mode depending on the motion of the sound collection apparatus 1.

FIG. 7 shows validated and invalidated states of the acceleration information and the distance information, as well as a sound collection state, in each of the operation modes. As shown in FIG. 7, the acceleration information generated by the acceleration sensor 230 is validated in any operation mode. The distance information generated by the distance sensor 240 is invalidated in the standby mode, the movement mode, and the finishing mode and is validated in the speaker identification mode and the sound collection mode. The acceleration information and the distance information are used when the information is validated. The distance information is not used when the information is invalidated. The sound collection (recording) is performed in the sound collection mode.

FIG. 8 shows the operation of the sound collection apparatus 1. In this embodiment, the operation shown in FIG. 8 is performed by the controller 110 of the electronic device 100. The controller 110 performs the operation shown in FIG. 8, for example, when the sound collection apparatus 1 is powered on. The controller 110 may perform the operation shown in FIG. 8 when an application for collecting a sound is activated. The operation shown in FIG. 8 is also referred to as a sound collection process. During the sound collection process, the acceleration sensor 230, the distance sensor 240, and the acoustic input part 250 are always in an ON state. In other words, during the sound collection process, the acceleration sensor 230 generates the acceleration information, the distance sensor 240 generates the distance information, and the acoustic input part 250 receives a sound around the sound collection apparatus 1 to generate an acoustic signal. Therefore, during the operation shown in FIG. 8, the electronic device 100 acquires the acceleration information, the distance information, and the acoustic signal from the measuring device 200. For example, before determinations at steps S1, S2, S3, S8, the mode switching part 111 acquires the acceleration information. Before determinations at steps S4, S6, the mode switching part 111 acquires the distance information.

In the standby mode, the mode switching part 111 validates the acceleration information and invalidates the distance information. The mode switching part ill determines whether the sound collection apparatus 1 has moved based on the acceleration information (S1). For example, when the host 10 picks up the sound collection apparatus 1 on the table 30, the acceleration information becomes larger than zero, and therefore, the mode switching part 111 detects that the sound collection apparatus 1 has moved and switches the operation mode from the standby mode to the movement mode. In this case, the mode switching part 111 may notify the speech section determining part 112 of the shift to the movement mode.

The mode switching part 111 determines whether the sound collection apparatus 1 is standing still based on the acceleration information (S2). When detecting the acceleration information indicating that the sound collection apparatus 1 is standing still after movement (Yes at S2), the mode switching part 111 calculates the posture or position of the sound collection apparatus 1 based on the acceleration information and determines whether the sound collection apparatus 1 is in the standby state (S3). Whether the apparatus is standing still is determined based on, for example, whether the angle of the sound collection apparatus 1 is substantially the same for a certain time. A posture or position of the sound collection apparatus 1 defined as the standby state may be stored in the controller 110 or the storage part 130. At S3, the calculated posture or position of the sound collection 1 may be compared with the stored posture or position defined as the standby state, and then the sound collection 1 may be determined to be in the standby state when the compared result is consistent.

If the sound collection apparatus 1 is in the standby state (Yes at S3), the mode switching part 111 returns the operation mode to the standby mode. Therefore, the process returns to step S1. For example, when the host 10 returns the sound collection apparatus 1 onto the table 30 again, the mode switching part 111 returns the operation mode to the standby mode. In this case, the mode switching part 111 may notify the speech section determining part 112 of the shift to the standby mode.

If the sound collection apparatus 1 is standing still in a state other than the standby state (No at S3), the mode switching part 111 switches the operation mode to the speaker identification mode and validates the distance information. For example, when the sound collection apparatus 1 held by the host 10 in the hand is kept still while being directed toward the guest 20, the mode is switched to the speaker identification mode. The mode switching part 111 may notify the speech section determining part 112 of the shift to the speaker identification mode. Within a predetermined time after the shift to the speaker identification mode, the mode switching part 111 determines whether a speaker is present within the predetermined distance d1 from the distance sensor 240 based on the distance information (S4). The predetermined distance d1 is about 20 cm, for example.

If it is detected that a speaker is present within the predetermined distance d1 from the distance sensor 240 within a predetermined time after the shift to the speaker identification mode (Yes at S4), the mode switching part 111 switches the operation mode to the sound collection mode. The mode switching part 111 notifies the speech section determining part 112 of the shift to the sound collection mode. In response to the notification of the shift to the sound collection mode, the speech section determining part 112 notifies the data processor 113 of the start of the speech section. In response to the notification of the start of the speech section, the data processor 113 starts collecting a sound (S5). Specifically, the data processor 113 stores in the storage part 130 an acoustic signal generated by the acoustic input part 250 receiving a sound. As a result, the sound is recorded.

If it is not detected that a speaker is present within the predetermined distance d1 from the distance sensor 240 within a predetermined time after the shift to the speaker identification mode (No at S4), the mode switching part 111 determines whether the sound collection apparatus 1 is moving based on the acceleration information (S8). For example, if the distance between the distance sensor 240 and a speaker is greater than the predetermined distance d1 within a predetermined time after the shift to the speaker identification mode, it is detected that no speaker is present within the predetermined distance d1. When it is detected that the sound collection apparatus 1 is moving (Yes at S8), the mode switching part 111 switches the operation mode to the movement mode (the process returns to S2), and when it is confirmed that the sound collection apparatus 1 is standing still (No at S8), the operation mode is switched to the standby mode (the process returns to S1). When the mode is shifted to the movement mode or the standby mode, the mode switching part 111 invalidates the distance information.

In the sound collection mode, the mode switching part 111 determines whether the speaker is present within the predetermined distance d1 from the distance sensor 240 based on the distance information (S6). If it is detected that the speaker has moved out of the range of the predetermined distance d1 from the sound collection apparatus 1 (No at S6) during the sound collection mode, the mode switching part 111 switches the operation mode to the finishing mode. The mode switching part 111 notifies the speech section determining part 112 of the shift to the finishing mode. In response to the notification of the shift to the finishing mode, the speech section determining part 112 notifies the data processor 113 of the end of the speech section. In response to the notification of the end of the speech section, the data processor 113 stops the sound collection (S7).

When the mode is shifted to the finishing mode, the mode switching part 111 invalidates the distance information. In the finishing mode, the mode switching part 111 determines whether the sound collection apparatus 1 is moving based on the acceleration information (S8). When it is detected that the sound collection apparatus 1 is moving (Yes at S8), the mode switching part 11.1 switches the operation mode to the movement mode (the process returns to S2), and when it is detected that the sound collection apparatus 1 is standing still (No at S8), the operation mode is switched to the standby mode (the process returns to S1).

In the finishing mode, the data processor 113 transmits, for example, acoustic signals corresponding to the speech section stored in the storage part 130 to the speech recognition server 3 to acquire speech recognition data. The data processor 113 may notify the mode switching part 111 of the acquisition of the speech recognition data, i.e., the completion of a speech recognition process. The mode switching part 111 may shift the finishing mode to the standby mode or the movement mode after the speech recognition process is completed.

The data processor 113 may store the acquired speech recognition data in the storage part 130. The data processor 113 may display a spoken sentence represented by the speech recognition data on the display 150. The data processor 113 may transmit the acquired speech recognition data to the translation server 4 to acquire translation data. The data processor 113 may store the translation data in the storage part 130 or may display a translated sentence represented by the translation data on the display 150. The data processor 113 may transmit the acquired translation data to the speech synthesis server 5 to acquire a speech signal corresponding to the translated sentence. The data processor 113 may output the speech signal corresponding to the translated sentence to the measuring device 200 and output the speech signal corresponding to the translated sentence from the acoustic output part 260 of the measuring device 200.

With the above operation, for example, the conversation made by each of the host 10 and the guest 20 can be recorded by only alternately changing the direction of the sound collection apparatus 1 (the side disposed with the distance sensor 240 and the sound input section 250) to the host 10 side or the guest 20 side without operating a recording button etc. In this case, when the sound collection apparatus 1 placed on the table 30 is lifted and while the direction of the sound collection apparatus 1 is changed (during movement), the distance information is invalidated so that recording is not started. Therefore, a sound other than the target sound, for example, an environmental noise, can be prevented from being recorded. Additionally, the sound collection apparatus 1 can communicate with the translation server 4 and the voice synthesizing server 5 to display translated sentences corresponding to speeches of the host 10 and the guest 20 on the display 150 or to output translated speeches corresponding to the speeches from the acoustic output part 260.

### 3. Effects and Supplements etc.

The sound collection apparatus 1 of this embodiment collects an acoustic signal. The sound collection apparatus 1 includes the distance sensor 240 (an example of a first sensor), the acceleration sensor 230 (an example of a second sensor), the acoustic input part 250 (an example of a sound acquisition part), and the controller 110. The distance sensor 240 detects a distance from the sound collection apparatus 1 to an object around the sound collection apparatus 1 and generates the distance information indicative of the distance. The acceleration sensor 230 detects an acceleration of the sound collection apparatus 1 and generates the acceleration information indicative of the acceleration. The acceleration information is an example of motion information indicative of the motion of the sound collection apparatus 1. The acoustic input part 250 receives a sound around the sound collection apparatus 1 and generates an acoustic signal. The controller 110 controls collection of the speech signal. Specifically, the controller 110 validates or invalidates the distance information based on the acceleration information (an example of the motion information) and determines whether to collect the speech signal when the distance information is validated, based on the distance information.

By limiting the valid period of the distance information based on the acceleration information in this way, a malfunction based on the distance information can be prevented, or specifically, a sound other than the target sound can be prevented from being collected. For example, when it is attempted to hold the sound collection apparatus 1 in the hand, the sound correction can be prevented from erroneously starting due to detection of a close distance to an object not emitting a target sound (e.g., the table 30). Additionally, for example, when the way of holding the sound collection apparatus 1 is changed, the sound correction can be prevented from erroneously starting due to the distance sensor 240 detecting a close distance to the hand or the body. As described above, by controlling the sound collection based on the acceleration information and the distance information, the sound collection section including the target sound can accurately be identified. Therefore, the target sound can accurately be collected. According to the sound collection apparatus 1 of this embodiment, since the target sound is automatically collected based on the distance information, for example, it is not necessary to operate a start button, an end button, etc. for speech each time a user speaks. As described above, the sound collection apparatus 1 of this embodiment improves the convenience at the time of sound collection.

When the acceleration information indicates that the sound collection apparatus 1 is standing still after movement, the controller 110 validates the invalidated distance information (the standby mode the movement mode the speaker identification mode). Therefore, for example, as shown in FIG. 5, the distance information is invalid until the sound collection apparatus 1 is moved from the table 30 and kept still by the host 10 while being directed toward the guest 20. Therefore, the sound collection apparatus 1 can be prevented from starting the sound collection due to the distance sensor 240 detecting a close distance to the table 30 or the host 10. Since the distance information is validated when the sound collection apparatus 1 stands still after the movement, the target sound, i.e., the speech of the guest 20, can be collected by the sound collection apparatus 1 kept still near the guest 20.

If the distance becomes equal to or less than the predetermined distance d1 within the predetermined time after the distance information is validated, the controller 110 starts collecting the acoustic signal (the speaker identification mode→the sound collection mode), and if the distance is larger than the predetermined distance d1, the controller 110 invalidates the distance information (the speaker identification mode the standby mode or the movement mode).

Therefore, for example, in the state shown in FIG. 5, when the sound collection apparatus 1 stands still after the movement, the sound collection is not started if the distance to the guest 20 is long, and the sound collection is started only when the distance to the guest 20 is short. As a result, the sound collection apparatus 1 is prevented from collecting sound before coming close to the guest 20 emitting the target sound. Since the sound collection is started after coming close the guest 20, the target sound, i.e., the speech of the guest 20, can accurately be collected.

When it is detected that the distance becomes larger than the predetermined distance d1 after starting the collection of the acoustic signal, the controller 110 terminates the sound collection and invalidates the distance information (the sound collection mode→the finishing mode). Therefore, for example, when the speech of the guest 20 ends and the host 10 attempts to return the sound collection apparatus 1 onto the table 30 or attempts to change the direction of the sound collection apparatus 1 from the guest 20 side to the host 10 side, the sound collection can automatically be terminated. As a result, a sound other than the target sound (speech) can be prevented from being collected.

### Other Embodiments

As described above, the embodiment has been described as an example of the technique disclosed in the present application. However, the technique in the present disclosure is not limited thereto and is also be applicable to embodiments with changes, substitutions, additions, omissions, etc. made as appropriate. Additionally, the constituent elements described in the embodiment can be combined to provide a new embodiment. Therefore, other embodiments will hereinafter be exemplified.

In the embodiment, when the speaker moves out of the range of the predetermined distance d1 from the sound collection apparatus 1 during the sound collection mode (No at S6), the mode is shifted to the finishing mode to stop the sound collection. Alternatively, when a predetermined time has elapsed from the start of the sound collection, the sound collection apparatus 1 may shift to the finishing mode to stop the sound collection.

If the distance from the distance sensor 240 to the speaker is smaller than a predetermined distance d2 in the speaker identification mode, the sound collection apparatus 1 may return to the standby mode or the movement mode without shifting to the sound collection mode. In this case, d2<d1 is satisfied. For example, the predetermined distance d1 is about 20 cm and the predetermined distance d2 is about 1 cm.

In the embodiment, the distance sensor 290 is always in the ON state during the sound collection process, and the sound collection apparatus 1 determines whether the distance information generated by the distance sensor 240 is validated or invalidated based on the acceleration information. However, instead of validating/invalidating, the distance sensor 240 may be switched on/off. Additionally, the acoustic input part 250 is always in the ON state during sound collection process and receives an ambient sound. However, the acoustic input part 250 may be in the ON state only in the sound collection mode and in the OFF state in the modes other than the sound collection mode. By setting the distance sensor 240 and the acoustic input part 250 to the OFF state, power consumption can be reduced.

If it is detected that the distance to the speaker becomes equal to or less than the predetermined distance d1 in the speaker identification mode, the sound collection apparatus 1 may output a notification sound for the start of sound collection from the acoustic output part 260. Not limited to the sound, a notification message for the start of sound collection may be displayed on the display 150, or a light source such as an LED may be turned on. If it is detected that the distance to the speaker becomes larger than the predetermined distance d1 in the sound collection mode, the sound collection apparatus 1 may output a notification sound for the end of sound collection from the acoustic output part 260. Not limited to the sound, a notification message for the end of sound collection may be displayed on the display 150, or a light source such as an LED may be turned off.

At step S4 of FIG. 8, the sound collection apparatus 1 determines whether the speaker is within the predetermined distance d1 from the distance sensor 240 based on the distance information. However, the distance sensor 240 may erroneously recognize an object that is not a speaker as a speaker. In this case, the sound collection apparatus 1 determines whether a speaker or an object exists within the predetermined distance d1 from the distance sensor 290 based on the distance information. When it is detected that a speaker or an object exists within the predetermined distance d1 from the distance sensor 240 (Yes at S9), the sound collection is started (S5). Based on the distance information and input information of the acoustic input part 250, it is determined whether the speaker is present within a predetermined distance d1 from the distance sensor 240 (S6). In other words, when a speech is input to the acoustic input part 250, it is determined at step S6 that a speaker is present.

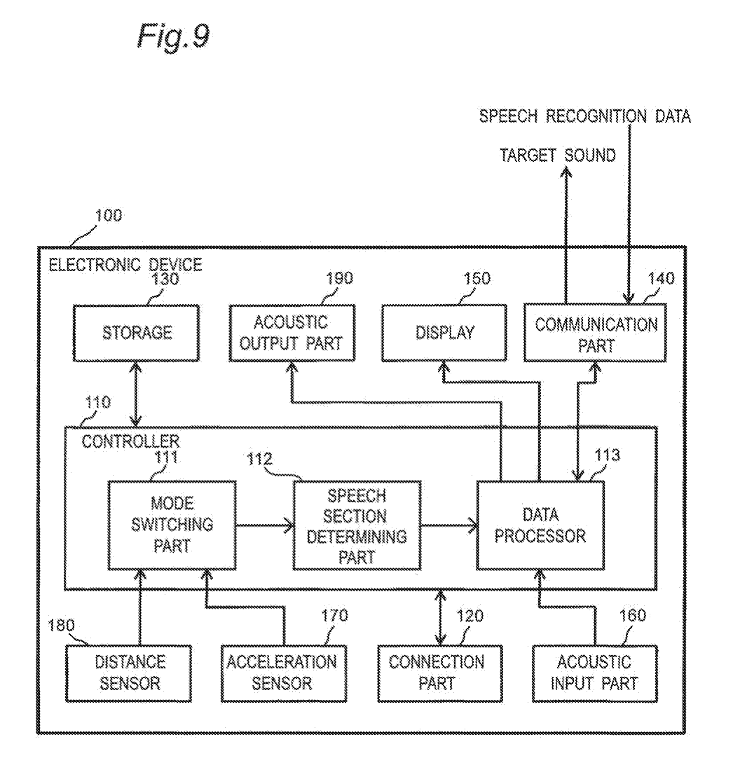

Although the acceleration sensor 230, the distance sensor 240, the acoustic input part (sound acquisition part) 250, and the acoustic output part 260 are disposed in the measuring device 200 in the embodiment, at least one of the acceleration sensor 230, the distance sensor 240, the acoustic input part 250, and the acoustic output part 260 may be disposed in the electronic device 100. For example, as shown in FIG. 9, the electronic device 100 may include the acceleration sensor 170, the distance sensor 180, the acoustic input part (sound acquisition part) 160, and the acoustic output part 190, and the sound collection apparatus 1 may be made up only of the electronic device 100. Alternatively, both the electronic device 100 and the measuring device 200 may have the functions of the acceleration sensor, the distance sensor, the acoustic input part, and the acoustic output part.

In the embodiment, the speech recognition is performed by the speech recognition server 3, the translation is performed by the translation server 4, and the speech synthesis is performed by the speech synthesis server 5; however, the present disclosure is not limited thereto. At least one process of the speech recognition, the translation, and the speech synthesis may be performed in the sound collection apparatus 1. For example, the sound collection apparatus 1 (terminal) may equipped with all the same functions as those of the speech recognition server 3, the translation server 4, and the speech synthesis server 5 so that all the processes related to translation are executed by only the sound collection apparatus 1.

In the embodiment, the acceleration information is used as an example of the motion information. The motion information may include angular velocity information indicative of the angular velocity of the sound collection apparatus 1 instead of or in addition to the acceleration information. For example, the sound collection apparatus 1 may include a gyro sensor detecting an angular velocity, and an angle may be calculated from the angular velocity of the sound collection apparatus 1. The sound collection apparatus 1 may switch the operation mode based on the calculated angle. For example, it may be determined based on the calculated angle whether the sound collection apparatus 1 is in the standby state.

In the embodiment, the sound collection is to record the target sound. However, the sound collection is not limited to recording a sound and includes processing an acoustic signal corresponding to a sound collection period.

In the example described in the embodiment, a human voice is collected as the target sound has been described; however, the target sound is not limited to a human voice. For example, the call of an animal or the sound of a car may be collected.

### Overview of Embodiments

(1) A sound collection apparatus of the present disclosure is a sound collection apparatus (1) collecting an acoustic signal, comprising a first sensor (240) detecting a distance from the sound collection apparatus to an object around the sound collection apparatus to generate distant information indicative of the distance, a second sensor (230) detecting a motion of the sound collection apparatus to generate motion information indicative of the motion, a sound acquisition part (250) receiving a sound around the sound collection apparatus to generate an acoustic signal, and a controller (110) controlling collection of the acoustic signal, wherein the controller validates or invalidates the distance information based on the motion information and determines whether to collect the acoustic signal based on the distance information when the distance information is validated.

As a result, since the valid period of the distance information is limited, a target sound can accurately be collected.

(2) In the sound collection apparatus of (1), the controller may validate the distance information when the motion information indicates that the sound collection apparatus stands still after movement (he standby mode→the movement mode the speaker identification mode).

As a result, the sound collection can be prevented from erroneously starting during movement of the sound collection apparatus.

(3) In the sound collection apparatus of (2), within a predetermined time after validating the distance information, the controller may start collecting the acoustic signal if the distance is equal to or less than a predetermined distance (the speaker identification mode→the sound collection mode), while the controller may invalidate the distance information if the distance is larger than the predetermined distance (the speaker identification mode the standby mode or the movement mode).

As a result, the sound collection is started only when an object (e.g., a person) is in the vicinity of the sound collection apparatus, so that a sound other than the target sound can be prevented from being collected. Therefore, the target sound can accurately be collected. Additionally, when the object is in the vicinity of the sound collection apparatus, the sound collection is automatically started, so that the user does not need to operate a sound collection start button etc. Therefore, the convenience is improved.

(4) In the sound collection apparatus of (3), when it is detected that the distance becomes larger than the predetermined distance after starting the collection of the acoustic signal, the controller may terminate the sound collection and invalidate the distance information (the sound collection mode the finishing mode).

As a result, when an object (e.g., a person) moves away the sound collection apparatus, the sound collection is completed, so that a sound other than the target sound, for example, an environmental noise, can be prevented from being collected.

(5) The sound collection apparatus of (1) may include a first device (100) including the controller and a second device (200) including at least one of the first sensor, the second sensor, and the sound acquisition part and electrically connected to the first device.

(6) The sound collection apparatus of (1) may put the first sensor into an OFF state when the distance information is invalidated.

As a result, power consumption can be reduced.

(7) A sound collection method of the present disclosure is a method of collecting an acoustic signal by a sound collection apparatus including a sound acquisition part receiving an surrounding sound and generating an acoustic signal and a controller. The sound collection method includes: acquiring distance information indicative of a distance from a first sensor by the controller, wherein the first sensor detects the distance from the sound collection apparatus to an object around the sound collection apparatus; acquiring motion information indicative of the motion by the controller, from a second sensor detecting a motion of the sound collection apparatus; determining by the controller whether to validate or invalidate the distance information based on the motion information; and determining by the controller whether to collect the acoustic signal based on the distance information when the distance information is validated.

The sound collection apparatus and the sound collection method according to all claims of the present disclosure are implemented by cooperation etc. with hardware resources, for example, a processor, a memory, and a program.

### INDUSTRIAL APPLICABILITY

The sound collection apparatus of the present disclosure is useful as an apparatus collecting a human voice during a conversation, for example.

### EXPLANATIONS OF LETTERS OR NUMERALS

1 sound collection apparatus
3 speech recognition server
4 translation server
5 speech synthesis server
100 electronic device
110, 210 controller
111 mode switching part
112 speech section determining part
113 data processor
120, 220 connection part
130 storage
140 communication part
150 display
160, 250 acoustic input part
170, 230 acceleration sensor
180, 240 distance sensor
190, 260 acoustic output part
200 measuring device

What is claimed is:

1. A sound collection apparatus collecting an acoustic signal, comprising:
a first sensor detecting a distance from the sound collection apparatus to an object around the sound collection apparatus to generate distant information indicative of the distance;
a second sensor detecting a motion of the sound collection apparatus to generate motion information indicative of the motion;
a sound acquisition part receiving a sound around the sound collection apparatus to generate an acoustic signal; and
a controller controlling collection of the acoustic signal, wherein
the controller validates or invalidates the distance information based on the motion information and determines whether to collect the acoustic signal based on the distance information when the distance information is validated.

2. The sound collection apparatus according to claim 1, wherein
the controller validates the distance information when the motion information indicates that the sound collection apparatus stands still after movement in a state other than a standby state.

3. The sound collection apparatus according to claim 2, wherein
within a predetermined time after validating the distance information,
the controller starts collecting the acoustic signal if the distance is equal to or less than a predetermined distance, while the controller invalidates the distance information if the distance is larger than the predetermined distance.

4. The sound collection apparatus according to claim 3, wherein
when it is detected that the distance becomes larger than the predetermined distance after starting the collection of the acoustic signal, the controller terminates the sound collection and invalidates the distance information

5. The sound collection apparatus according to claim 1, comprising
a first device including the controller, and
a second device including at least one of the first sensor, the second sensor, and the sound acquisition part and electrically connected to the first device.

6. The sound collection apparatus according to claim 1, wherein
the first sensor is put into an OFF state when the distance information is invalidated.

7. A sound collection method of collecting an acoustic signal by a sound collection apparatus including a sound acquisition part receiving a surrounding sound and generating an acoustic signal and a controller, the method comprising:
acquiring distance information indicative of a distance from a first sensor by the controller, wherein the first sensor detects the distance from the sound collection apparatus to an object around the sound collection apparatus;
acquiring motion information indicative of the motion by the controller, from a second sensor detecting a motion of the sound collection apparatus;
determining by the controller whether to validate or invalidate the distance information based on the motion information; and
determining by the controller whether to collect the acoustic signal based on the distance information when the distance information is validated.
